(19) United States
(12) Patent Application Publication
(10) Pub. No.: US 2013/0328789 A1
(43) Pub. Date: Dec. 12, 2013

(54) TOUCH DEVICE AND OPERATING METHOD THEREOF

(71) Applicants: Jui-Ming Liu, Tainan City (TW); Chung-Wen Chang, Tainan City (TW); Feng-Wei Yang, Tainan City (TW); Shen-Feng Tai, Tainan City (TW)

(72) Inventors: Jui-Ming Liu, Tainan City (TW); Chung-Wen Chang, Tainan City (TW); Feng-Wei Yang, Tainan City (TW); Shen-Feng Tai, Tainan City (TW)

(73) Assignee: HIMAX TECHNOLOGIES LIMITED, Tainan City (TW)

(21) Appl. No.: 13/492,428

(22) Filed: Jun. 8, 2012

(51) Int. Cl. G06F 3/041

(52) U.S. Cl. 345/173

(57) ABSTRACT

A touch device and an operating method of the touch device are provided. The operating method includes following steps. A plurality of touch values of a touch panel are obtained. During a first frame period, the obtained touch values are stored in a first memory unit, and a touch point is calculated according to the touch values stored in a second memory unit. During a second frame period, the obtained touch values are stored in the second memory unit, and the touch point is calculated according to the touch values stored in the first memory unit.

### BACKGROUND OF THE INVENTION

1. Field of the Invention

The invention relates to a touch technology. More particularly, the invention relates to a touch device and an operating method thereof.

2. Description of Related Art

As information technology, wireless mobile communication, and information home appliances have been rapidly developed and applied, input devices of a number of information products have evolved from conventional keyboards and mice to touch panels for the purposes of convenience, miniaturization, and being user-friendly. Besides, the touch panel may be applied together with a display panel to achieve the function of selecting an object. Generally, touch panels can be categorized into resistive touch panels, capacitive touch panels, optical touch panels, sound wave touch panels, electromagnetic touch panels, and so on.

During a scan frame period, the driving circuit of the touch panel detects the touch panel, so as to obtain a plurality of touch values of the touch panel. According to the obtained touch values, the driving circuit of the touch panel determines whether the touch panel has any touch point and, if yes, determines the position of the touch point. Owing to the increasing dimension of the display panel, the time required for detecting the touch panel increases, and so does the number of touch values detected by the driving circuit. Thereby, the time required for processing the touch values increases as well. Nonetheless, the scan frame period remains unchanged. In other words, the scan frequency of the driving circuit increases to reduce the time required for detecting the touch panel. Besides, the operating speed of the driving circuit also increases to reduce the time required for processing the touch values. The scan frequency rise and the expedited operating speed of the driving circuit lead to an increase in the hardware cost of the driving circuit, thus affecting the overall hardware costs of the touch device.

### SUMMARY OF THE INVENTION

The invention is directed to a touch device and an operating method of the touch device capable of detecting touch points without increasing scan frequency and operating speed of a driving circuit, such that an increase in the overall hardware costs of the touch device can be prevented.

In an embodiment of the invention, a touch device that includes a touch panel, a first memory unit, a second memory unit, a touch detection unit, and a touch point calculation unit is provided. The touch detection unit is coupled to the touch panel, the first memory unit, and the second memory unit for detecting the touch panel to obtain a plurality of touch values. The touch values are stored in the first memory unit during a first frame period and stored in the second memory unit during a second frame period. The touch point calculation unit is coupled to the first memory unit and the second memory unit. During the first frame period, the touch point calculation unit calculates a touch point according to the touch values stored in the second memory unit; during the second frame period, the touch point calculation unit calculates the touch point according to the touch values stored in the first memory unit.

According to an embodiment of the invention, the touch detection unit includes a value converting unit and a first multiplexer. The value converting unit is coupled to the touch panel for detecting the touch panel to obtain a plurality of touch data and converting the touch data into the touch values. The first multiplexer has a first input end, a first output end, a second output end, and a first control end. The first input end is coupled to the value converting unit, the first output end is coupled to the first memory unit, the second output end is coupled to the second memory unit, and the first control end receives a time sequence signal. The first input end is coupled to the first output end during the first frame period and coupled to the second output end during the second frame period.

According to an embodiment of the invention, the touch point calculating unit includes a second multiplexer and an operating unit. The second multiplexer has a second input end, a third input end, a third output end, and a second control end. The second input end is coupled to the first memory unit, the third input end is coupled to the second memory unit, and the second control end receives the time sequence signal. The third output end is coupled to the third input end during the first frame period and coupled to the second input end during the second frame period. The operating unit is coupled to the third output end and calculates the touch point according to the touch values stored in the first memory unit or the second memory unit.

In an embodiment of the invention, an operating method of a touch device includes following steps. A plurality of touch values of a touch panel are obtained. During a first frame period, the obtained touch values are stored in a first memory unit, and a touch point is calculated according to the touch values stored in a second memory unit. During a second frame period, the obtained touch values are stored in the second memory unit, and the touch point is calculated according to the touch values stored in the first memory unit.

According to an embodiment of the invention, steps of obtaining the touch values output by the touch panel includes: obtaining a plurality of touch data output by the touch panel and converting the touch data into the touch values.

According to an embodiment of the invention, the touch panel is a capacitive touch panel, and the touch data are capacitance values.

According to an embodiment of the invention, the touch panel is a resistive touch panel, and the touch data are voltage values.

Based on the above, in the touch device and the operating method thereof described in the embodiments of the invention, the first memory unit store the touch values output by the touch detection unit while the second memory unit provide the touch values to the touch point calculation unit, and the first memory unit provide the touch values to the touch point calculation unit while the second memory unit store the touch values output by the touch detection unit. Hence, the operation of the touch detection unit is independent from the operation of the touch point calculation unit. Thereby, the hardware cost increase caused by both the significant scan frequency rise of the touch detection unit and the expedited operating speed of the touch point calculation unit can be prevented.

Other features and advantages of the invention will be further understood from the further technological features disclosed by the embodiments of the invention wherein there are shown and described embodiments of this invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a systematic view schematically illustrating a touch device according to an embodiment of the invention.

FIG. 2 schematically illustrates detection of the touch device depicted in FIG. 1 according to an embodiment of the invention.

FIG. 3 schematically illustrates circuitry of the touch detection unit depicted in FIG. 1 according to an embodiment of the invention.

FIG. 4 schematically illustrates circuitry of the touch point calculation unit depicted in FIG. 1 according to an embodiment of the invention.

FIG. 5 is a flow chart illustrating an operating method of a touch device according to an embodiment of the invention.

### DESCRIPTION OF EMBODIMENTS

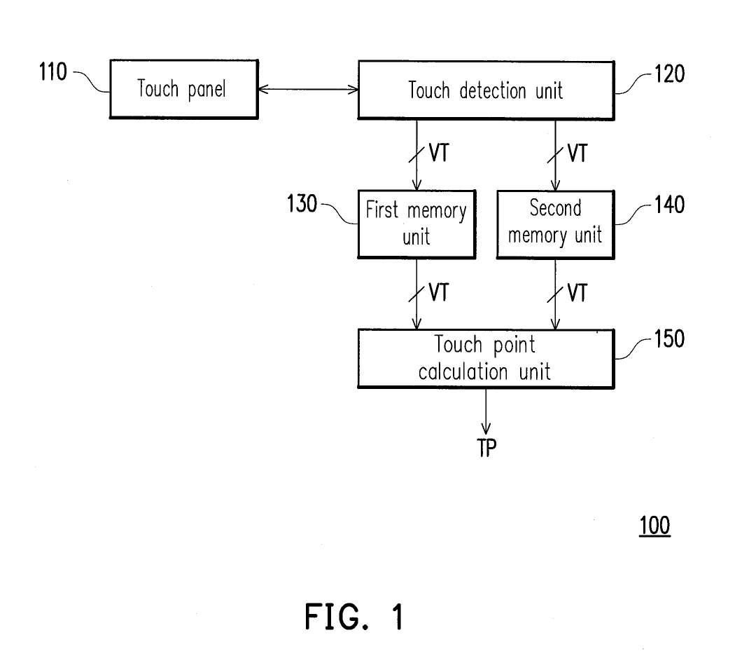

FIG. 1 is a systematic view schematically illustrating a touch device according to an embodiment of the invention. With reference to FIG. 1, in the present embodiment, the touch device 100 includes a touch panel 110, a touch detection unit 120, a first memory unit 130, a second memory unit 140, and a touch point calculation unit 150. The touch panel 110 may be a resistive touch panel or a capacitive touch panel, which should not be construed as a limitation to the invention. The touch detection unit 120 is coupled to the touch panel 110, the first memory unit 130, and the second memory unit 140. Here, the touch detection unit 120 detects the touch panel 110 to obtain a plurality of touch values VT and alternately stores the touch values VT into the first memory unit 130 or the second memory unit 140 according to a time sequence.

The touch point calculation unit 150 is coupled to the first memory unit 130 and the second memory unit 140 to obtain the touch values VT from the first memory unit 130 or the second memory unit 140 and calculate a touch point TP according to the obtained touch values VT. One of the first memory unit 130 and the second memory unit 140 stores the touch values VT obtained by the touch detection unit 120, and the other outputs the stored touch values VT.

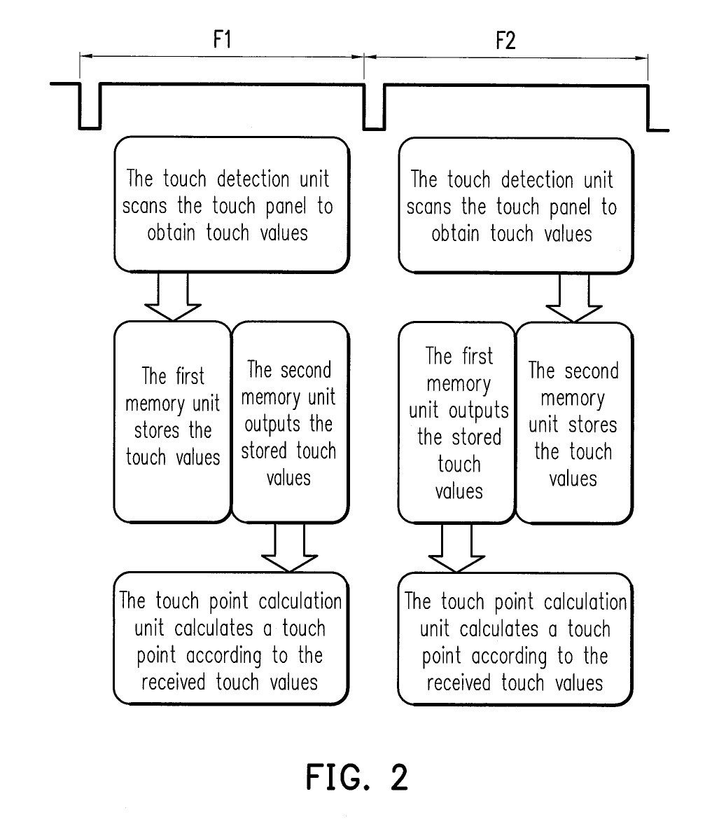

FIG. 2 schematically illustrates detection of the touch device depicted in FIG. 1 according to an embodiment of the invention. As shown in FIG. 1 and FIG. 2, during a first frame period F1, the touch detection unit 120 detects the touch panel 110 to obtain the touch values VT and stores the touch values VT into the first memory unit 130. At the same time, the touch point calculation unit 150 receives the touch values VT from the second memory unit 140 and calculates the touch point TP according to the received touch values VT.

During a second frame period F2, the touch detection unit 120 also detects the touch panel 110 to obtain the touch values VT but stores the touch values VT into the second memory unit 140. Similarly, the touch point calculation unit 150 receives the touch values VT from the first memory unit 130 and calculates the touch point TP according to the received touch values VT.

Based on the above, the touch detection unit 120 stores the detected touch values VT into one of the first memory unit 130 and the second memory unit 140, and the touch point calculation unit 150 obtains the touch values VT from the other one of the first memory unit 130 and the second memory unit 140. Hence, the operation of the touch detection unit 120 and the operation of the touch point calculation unit 150 are not mutually affected. The touch detection unit 120 may detect the touch panel 110 during the entire frame period (e.g., the first and second frame periods F1 and F2), and the touch point calculation unit 150 can also calculate the touch point TP during the entire frame period. Thereby, the touch detection unit 120 may have time to detect the touch panel 110, thus preventing the hardware cost increase caused by the significant scan frequency rise of the touch detection unit 120. In addition, the touch point calculation unit 150 may have time to calculate the touch point TP as well; therefore, the operating speed of the touch point calculation unit 150 need not be expedited to a great extent, and the hardware cost of the touch device 100 is thus not increased.

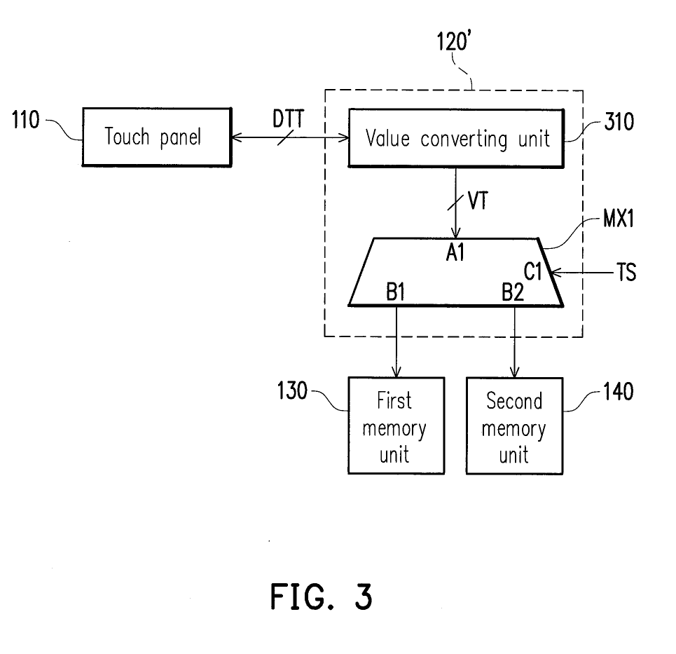

FIG. 3 schematically illustrates circuitry of the touch detection unit depicted in FIG. 1 according to an embodiment of the invention. As shown in FIG. 1 and FIG. 3, in the present embodiment, the touch detection unit 120′ includes a value converting unit 310 and a first multiplexer MX1. The value converting unit 310 is coupled to the touch panel 110 for detecting the touch panel 110 to obtain a plurality of touch data DTT. Each of the touch data DTT corresponds to one touch data base value, and the value converting unit 310 converts the touch data DTT into the touch values VT according to the touch data base values respectively corresponding to the touch data DTT. If the touch panel 110 is a capacitive touch panel, the touch data DTT may be capacitance values; if the touch panel 110 is a resistive touch panel, the touch data DTT may be voltage values.

The first multiplexer MX1 has a first input end A1, a first output end B1, a second output end B2, and a first control end C1. The first input end A1 is coupled to the value converting unit 310 to receive the touch values VT from the value converting unit 310. The first output end B1 is coupled to the first memory unit 130, and the second output end B2 is coupled to the second memory unit 140. The first control end C1 receives a time sequence signal TS. Here, the first input end A1 of the first multiplexer MX1 is coupled to the first output end B1 or the second output end B2 according to the time sequence signal TS.

With reference to FIG. 2 and FIG. 3, to be more specific, the first input end A1 of the first multiplexer MX1 is coupled to the first output end B1 during the first frame period F1 according to the time sequence signal TS; therefore, the touch values VT output by the value converting unit 310 are transmitted to the first memory unit 130 via the first multiplexer MX1 to store the touch values VT into the first memory unit 130. During the second frame period F2, the first input end A1 of the first multiplexer MX1 is coupled to the second output end B2 according to the time sequence signal TS; therefore, the touch values VT output by the value converting unit 310 are transmitted to the second memory unit 140 via the first multiplexer MX1 to store the touch values VT into the second memory unit 140.

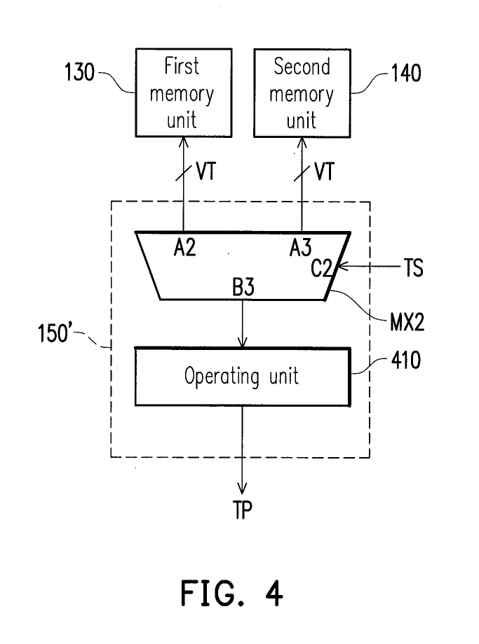

FIG. 4 schematically illustrates circuitry of the touch point calculation unit depicted in FIG. 1 according to an embodiment of the invention. As shown in FIG. 1 and FIG. 4, in the present embodiment, the touch point calculating unit 150′ includes a second multiplexer MX2 and an operating unit 410. The second multiplexer MX2 has a second input end A2, a third input end A3, a third output end B3, and a second control end C2. The second input end A2 is coupled to the first memory unit 130 to receive the touch values VT from the first memory unit 130. The third input end A3 is coupled to the second memory unit 140 to receive the touch values VT from the second memory unit 140. The second control end C2 receives the time sequence signal TS. Here, the third output end B3 of the second multiplexer MX2 is coupled to the second input end A2 or the third input end A3 according to the time sequence signal TS. The operating unit 410 is coupled to the third output end B3 and calculates the touch point TP according to the received touch values VT.

With reference to FIG. 2 and FIG. 4, to be more specific, the third input end A3 of the second multiplexer MX2 is coupled to the third output end B3 during the first frame period F1 according to the time sequence signal TS, and therefore the touch values VT output by the second memory unit 140 are transmitted to the operating unit 410 via the second multiplexer MX2. During the second frame period F2, the second input end A2 of the second multiplexer MX2 is coupled to the third output end B3 according to the time sequence signal TS, and therefore the touch values VT output by the first memory unit 130 are transmitted to the operating unit 410 via the second multiplexer MX2.

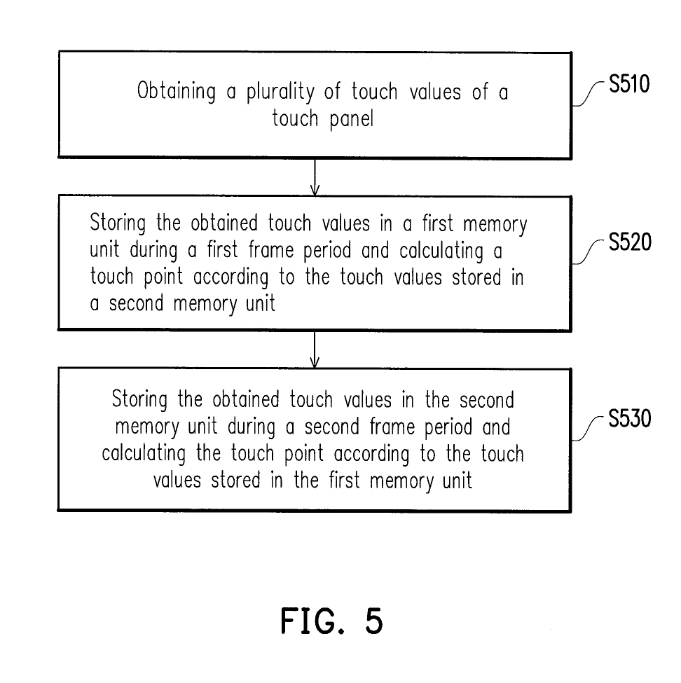

FIG. 5 is a flow chart illustrating an operating method of a touch device according to an embodiment of the invention. As illustrated in FIG. 5, according to the operating method described in the present embodiment, a plurality of touch values of a touch panel are obtained in step S510. During a first frame period, the obtained touch values are stored in a first memory unit, and a touch point is calculated according to the touch values stored in a second memory unit (step S520). During a second frame period, the obtained touch values are stored in the second memory unit, and the touch point is calculated according to the touch values stored in the first memory unit (step S530). The order of said steps is exemplary and should not be construed as a limitation to the invention. Detailed steps can be referred to as those described in the embodiments shown in FIG. 1 to FIG. 4, and thus no further description is provided hereinafter.

To sum up in the touch device and the operating method thereof described in the embodiments of the invention, the first memory unit store the touch values output by the touch detection unit while the second memory unit provide the touch values to the touch point calculation unit, and the first memory unit provide the touch values to the touch point calculation unit while the second memory unit store the touch values output by the touch detection unit. Hence, the operation of the touch detection unit is independent from the operation of the touch point calculation unit. Thereby, the hardware cost increase caused by both the significant scan frequency rise of the touch detection unit and the expedited operating speed of the touch point calculation unit can be prevented.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch device comprising:
a touch panel;
a first memory unit;
a second memory unit;
a touch detection unit coupled to the touch panel, the first memory unit, and the second memory unit for detecting the touch panel to obtain a plurality of touch values, the touch values being stored in the first memory unit during a first frame period and stored in the second memory unit during a second frame period; and
a touch point calculation unit coupled to the first memory unit and the second memory unit, the touch point calculation unit calculating a touch point during the first frame period according to the touch values stored in the second memory unit and calculating the touch point during the second frame period according to the touch values stored in the first memory unit.

2. The touch device as recited in claim 1, wherein the touch detection unit comprises:
a value converting unit coupled to the touch panel for detecting the touch panel to obtain a plurality of touch data and converting the touch data into the touch values; and
a first multiplexer having a first input end, a first output end, a second output end, and a first control end, the first input end being coupled to the value converting unit, the first output end being coupled to the first memory unit, the second output end being coupled to the second memory unit, the first control end receiving a time sequence signal, wherein the first input end is, according to the time sequence signal, coupled to the first output end during the first frame period and coupled to the second output end during the second frame period.

3. The touch device as recited in claim 2, wherein the touch point calculation unit comprises:
a second multiplexer having a second input end, a third input end, a third output end, and a second control end, the second input end being coupled to the first memory unit, the third input end being coupled to the second memory unit, the second control end receiving the time sequence signal, wherein the third output end is, according to the time sequence signal, coupled to the third input end during the first frame period and coupled to the second input end during the second frame period; and
an operating unit coupled to the third output end, the operating unit calculating the touch point according to the touch values stored in the first memory unit or the second memory unit.

4. The touch device as recited in claim 2, wherein the touch panel is a capacitive touch panel, and the touch data are capacitance values.

5. The touch device as recited in claim 2, wherein the touch panel is a resistive touch panel, and the touch data are voltage values.

6. An operating method of a touch device, comprising:
obtaining a plurality of touch values of a touch panel;
storing the obtained touch values in a first memory unit during a first frame period and calculating a touch point according to the touch values stored in a second memory unit; and
storing the obtained touch values in the second memory unit during a second frame period and calculating the touch point according to the touch values stored in the first memory unit.

7. The operating method of the touch device as recited in claim 6, wherein steps of obtaining the touch values output by the touch panel comprise:
obtaining a plurality of touch data output by the touch panel; and
converting the touch data into the touch values.

8. The operating method of the touch device as recited in claim 7, wherein the touch panel is a capacitive touch panel, and the touch data are capacitance values.

9. The operating method of the touch device as recited in claim 7, wherein the touch panel is a resistive touch panel, and the touch data are voltage values.
